(19) United States
(12) Patent Application Publication
(10) Pub. No.: US 2004/0225804 A1
(43) Pub. Date: Nov. 11, 2004

(54) Power supply with bus hub

(75) Inventor: Brian A. Leete, Beaverton, OR (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 09/730,238

(22) Filed: Dec. 5, 2000

(51) Int. Cl. G06F 13/38; G06F 13/40

(52) U.S. Cl. 710/305

(57) ABSTRACT

An apparatus, computing unit, and cable for attaching peripheral devices to a computer. A power hub contains both a bus hub and a power supply. The bus hub is capable of attaching peripheral devices to the computer. A cable connects the power hub to a computer. The cable carries both power from the power supply to the computer and data signals between the computer and the power hub.

### FIELD

This invention relates generally to computers and more particularly to the attachment of devices to computers.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright © Intel, Incorporated, 2000. All Rights Reserved.

### BACKGROUND

Contemporary computer systems generally consist of a main unit, a keyboard, and a monitor. The main unit typically contains a processor, memory, and a limited number of built-in storage devices, such as floppy disks, hard disks, and a CD-ROM. The main unit can be connected to a display monitor and potentially to many other peripheral devices, such as a keyboard, a mouse, a camera, a modem, a scanner, a telephone, and a printer. But, a standard computer system supports only a limited number of interface slots, so only a limited number of peripheral devices can be connected to the computer system at any one time. In addition, many peripheral devices have unique connectors that may not be interchangeable, so the devices must be carefully plugged into corresponding connectors of the interface slots of the computer system.

In order to relieve cable congestion, reduce the number of connectors contained in the computer system, and increase the number and speed of peripheral devices that can be connected to a computer simultaneously, a universal serial bus (USB) hub has been developed to serve as a central connection point of the computer system for power and data distribution to a wide variety of peripheral devices. Multiple sub-universal serial bus hubs can be connected to a main universal serial bus hub for power and data distribution to as many peripheral devices as desired.

But, a laptop or notebook computer has a smaller size and even fewer available interface slots than does a standard desktop computer, so attaching peripheral devices to a USB hub within a laptop computer is still problematic because the USB hub adds size and weight to the laptop computer. Without a better way to attach devices, users will not be able to take full advantage of laptop computers.

### BRIEF DESCRIPTION OF THE DRAWINGS

FIG. 1 depicts a pictorial example of a power hub connected to a computer via a cable, according to an embodiment of the invention.

FIG. 2 depicts a pictorial example showing more detail of selected elements of the cable.

FIG. 3A depicts a front view of a cable connector that connects to a computer, according to an embodiment of the invention.

FIG. 3B depicts a front view of a cable connector that connects to a power hub, according to an embodiment of the invention.

FIG. 4 depicts a block diagram of selected elements of the power hub, according to an embodiment of the invention.

FIG. 5 depicts a block diagram of a computer that can be used in an embodiment of the invention.

### DETAILED DESCRIPTION

In the following detailed description of exemplary embodiments of the invention, reference is made to the accompanying drawings (where like numbers represent like elements) that form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

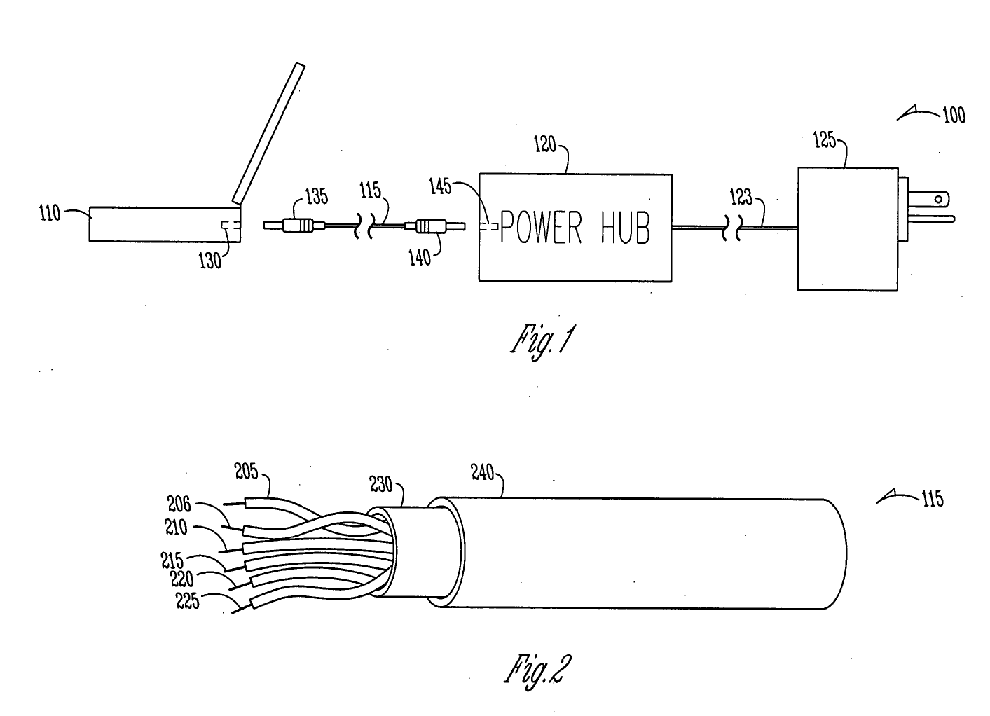

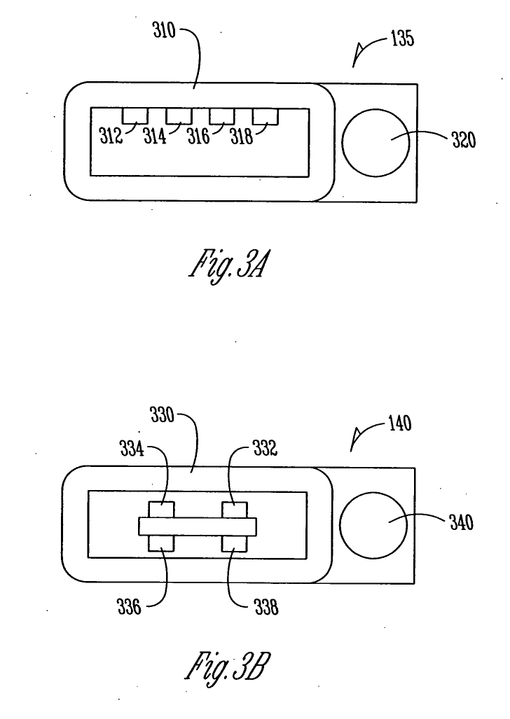

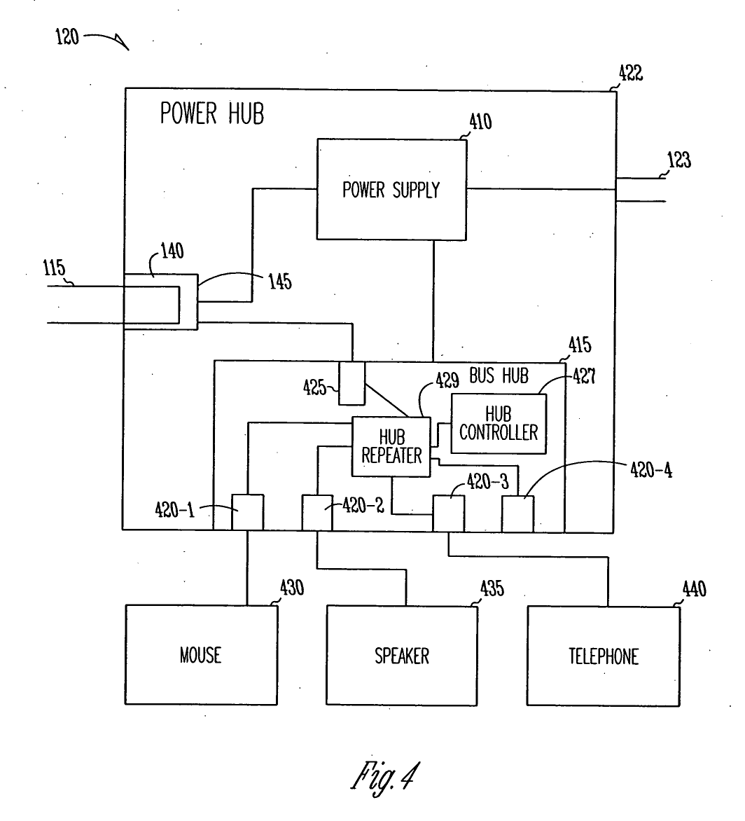

FIG. 1 depicts a pictorial example of a power hub connected to a computer via a cable, according to an embodiment of the invention. Computing unit 100 contains computer 110 connected via cable 115 to power hub unit 120. Cable 115 contains upstream plug 135 and downstream plug 140. Cable 115 is further described with reference to FIG. 2. Upstream plug 135 is further described with reference to FIG. 3A. Downstream plug 140 is further described with reference to FIG. 3B. Computer 110 contains upstream bus receptacle/power receptacle 130, which is capable of receiving upstream plug 135 of cable 115. Computer 110 is further described with reference to FIG. 5.

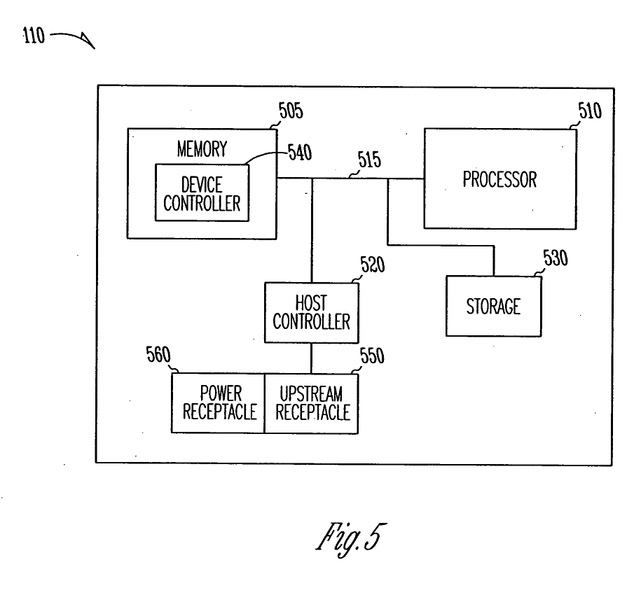

Power hub unit 120 receives an alternating current source of power through house plug 125 via wire 123. Power hub 120 is further described with reference to FIG. 4. Power hub 120 contains downstream receptacle 145, which is capable of receiving downstream plug 140 of cable 115. Downstream receptacle 145 contains both a downstream bus receptacle and a power receptacle that provides DC power.

FIG. 2 depicts a block diagram showing more detail of selected elements of cable 115, according to an embodiment of the invention. Cable 115 contains signal twisted pair wires 205 and 206, device power 210, device ground wire 215, computer power wire 220, and computer ground wire 225. All the wires are enclosed in foil shield 230, which is enclosed in PVC (polyvinyl chloride) jacket 240. In one embodiment, foil shield 230 is composed of aluminum metallized polyester. In another embodiment, foil shield 230 is optional. Although a PVC jacket is used in one embodiment, any appropriate electrical insulator can be used. Although the embodiment illustrated in FIG. 2 shows twisted pair signal wires, in other embodiments any appropriate signaling medium could be used, such as a non-twisted pair or fiber optic channel. In another embodiment a tinned copper drain wire is also contained in cable 115. In another embodiment, cable 115 also contains an interwoven tinned copper braid.

Signal twisted pair wires 205 and 206 carry data signals between computer 110 and power hub 120. Device power wire 210 provides power from computer 110 to bus-powered devices. Devices include not only peripheral devices that attach to computer 110, but also bus hubs. A bus-powered device is one that obtains its power from the bus. In contrast to a bus-powered device, a self-powered device obtains its power from an external source that is not the bus.

Computer power wire 220 provides DC (direct current) electrical power from power hub 120 to computer 110. In one embodiment device power wire 210 provides nominal DC+5 volts, and wires 205, 206, 210, and 215 make up a USB cable. In another embodiment, the Fiber Channel serial bus is used. In still another embodiment, the Fire Wire bus is used.

The universal serial bus (USB) is a protocol for a serial bus and is intended to replace the RS-232 serial bus. USB supports data exchange between a host computer and a wide range of simultaneously accessible peripherals. The attached peripherals share USB bandwidth through a host scheduled token-based protocol. The USB allows peripherals to be attached, configured, used, and detached while the host and other peripherals are in operation.

One of the purposes behind the universal serial bus is to provide ease of use to add PC peripherals. The USB is designed so that external devices may be correctly detected and properly configured upon attachment. The USB is designed to handle a broad range of devices such as telephones (both analog, digital, and proprietary), modems, printers, mice, joysticks, scanners, keyboards, and tablets. Therefore, in one embodiment the parallel, serial, graphics, modem, sound/game, and mouse ports are removed from computer 110 and are instead attached to power hub 120.

FIG. 3A depicts a front view of upstream plug 135, which connects cable 115 to upstream receptacle/power receptacle 130 of computer 110, according to an embodiment of the invention. Upstream plug 135 contains bus connection 310 and computer power plug 320. Bus connection 310 contains contact ribbons 312, 314, 316, and 318. Contact ribbon 312 connects to device power wire 210. Contact ribbon 314 connects to data signal wire (D−) 205. Contact ribbon 316 connects to data signal wire (D+) 206. Contact ribbon 318 connects to device ground wire 215. Computer power plug 320 connects to computer power wire 220 and computer ground wire 225.

FIG. 3B depicts a front view of downstream plug 140, which connects cable 115 to power hub 120, according to an embodiment of the invention. Downstream plug 140 contains bus connection 330 and computer power connection 340. Bus connection 330 contains contact ribbons 332, 334, 336, and 338. Contact ribbon 332 connects to device power wire 210. Contact ribbon 334 connects to data signal wire (D−) 205. Contact ribbon 336 connects to data signal wire (D+) 206. Contact ribbon 338 connects to device ground wire 215. Computer power connection 340 connects to computer power wire 220 and computer ground wire 225.

FIG. 4 depicts a block diagram of selected elements of the power hub, according to an embodiment of the invention. Power hub 120 contains housing 422, to which downstream receptacle 145, power supply 410, and bus hub 415 are attached. Downstream receptacle 145 is adapted to receive downstream plug 140 of cable 115.

In one embodiment, power supply 410 converts AC (alternating current) from wire 123 into DC (direct current) that is suitable for powering computer 110. The direct current is delivered to downstream receptacle 145 and carried over cable 115 to computer 110. Power supply 410 also supplies power to bus hub 415 when it operates in self-powered mode. In another embodiment, power supply 410 is any kind of device that supplies electric power.

Bus hub 415 accepts data packets from computer 110 and forwards them to an attached peripheral device that can use them. Bus hub 415 also serves to move data from the attached peripheral devices to computer 110. Bus hub 415 also accepts and generates packets itself to ensure that the devices and computer 110 have a clear virtual pathway between them.

Bus hub 415 contains downstream ports 420-1, 420-2, 420-3, and 420-4, upstream port 425 (also called the root port), hub controller 427, and hub repeater 429. Upstream port 425 is connected to downstream receptacle 145. Hub repeater 429 is connected to downstream ports 420-1, 420-2, 420-3, and 420-4 and upstream port 425. Hub controller 427 is connected to hub repeater 429. Downstream port 420-1 is connected to mouse 430. Downstream port 420-2 is connected to speaker 435. Downstream port 420-3 is connected to telephone 440. Peripheral devices 430, 435, and 440 can be self powered or bus powered. When they are bus powered, they receive their power through the bus (wires 210 and 215). When they are self powered, they receive their power through an external source, such as being plugged into an unillustrated wall socket or from power supply 410.

Although four downstream ports are shown in FIG. 4, in other embodiments any number of downstream ports can be present. Although the peripheral devices illustrated in FIG. 4 are a mouse, a speaker, and a telephone, in other embodiments any input/output devices may be present, such as a keyboard, joystick, camera, modem, scanner, and a printer.

Hub controller 427 performs the routing of the signals from upstream port 425 to downstream ports 420-1, 420-2, 420-3, and 420-4 and from the downstream ports to upstream port 425. Hub controller 427 also performs error detection and recovery. Hub controller 427 supports two power source modes: bus-powered and self-powered. Ordinarily, if the power required for the downstream ports and embedded functions is equal to or less than the power the bus can supply, hub controller 427 can be powered by the bus (wires 210 and 215), in which case bus hub 415 is said to be bus powered. If the power required for the downstream ports and embedded functions is more than what the bus can supply, hub controller 427 and the downstream ports may be self-powered by power supply 410. Thus, just like peripheral devices 430, 435 and 440, bus hub 415 can be bus powered or self powered.

Hub repeater 429 manages the setup and destruction of connections to and through bus hub 415. Hub repeater 429 also detects whether a peripheral device, such as mouse 430, speaker 435, or telephone 440 has been attached or removed.

In one embodiment, hub controller 427 and hub repeater 429 contain memory storing instructions that are executable by a processor. In another embodiment, hub controller 427 and repeater 429 are implemented by control circuitry though the use of logic gates, programmable logic devices, or other hardware components in lieu of a processor-based system. Although hub controller 427 and hub repeater 429 are shown to be separate components in the embodiment illustrated in FIG. 4, in another embodiment they may be packaged together.

FIG. 5 depicts a block diagram of a computer system that can be used in an embodiment of the invention. Computer system 110 includes memory 505, processor 510, and host controller 520, which are all coupled via system bus 515. Computer 110 further includes upstream bus receptacle 550, which is coupled to host controller 520. Upstream bus receptacle 550 receives bus connection 310 in upstream plug 135. Computer 110 further includes power receptacle 560, which receives power plug 320 in upstream plug 135. Although the various components of FIG. 5 are drawn as single entities, each may consist of multiple entities and may exist at multiple levels.

Memory 505 comprises a number of individual, volatile-memory modules that store segments of operating system and application software while power is supplied to computer 110. The software segments are partitioned into one or more virtual memory pages that each contains a uniform number of virtual memory addresses. When the execution of software requires more pages of virtual memory than can be stored within memory 505, pages that are not currently needed are swapped with the required pages, which are stored within non-volatile storage 530. Memory 505 is a type of memory designed such that the location of data stored in it is independent of the content. Also, any location in memory 505 can be accessed directly without needing to start from the beginning.

Memory 505 contains device controller 540, which contains instructions capable of being executed by processor 510. In the alternative, device controller 540 is implemented by control circuitry though the use of logic gates, programmable logic devices, or other hardware components. Device controller 540 detects the attachment and removal of peripheral devices attached to power hub 120, such as peripheral devices 430, 435, and 440. Device controller 540 also manages data transfers between computer 110 and the peripheral devices and controls the electrical power to those peripheral devices that are bus powered.

Processor 510 executes instructions and includes that portion of computer 110 that controls the operation of the entire computer system, including executing the arithmetical and logical functions contained in a particular computer program. Although not depicted in FIG. 5, processor 510 typically includes a control unit that organizes data and program storage in a computer memory and transfers data and other information between the various part of the computer system. Processor 510 accesses data and instructions from and stores data to memory 505.

Any appropriate processor could be utilized for processor 510. Although computer 110 is shown to contain only a single processor and a single system bus, the present invention applies equally to computer systems that have multiple processors and to computer systems that have multiple buses that each performs different functions in different ways.

Storage 530 can be implemented as a diskette drive, hard-disk drive, tape drive, CD-ROM, or any other non-volatile storage device. Although storage 530 is shown as part of computer 110, in another embodiment, it is external to computer 110, either connected directly, on a network, or attached to a remote computer.

Power receptacle 560 receives direct current through power plug 320. In one embodiment, power receptacle 560 is connected to an unillustrated power supply that distributes power to the various components of computer 110. In another embodiment, power receptacle 560 is connected to an unillustrated battery.

The hardware depicted in FIG. 5 may vary for specific applications. For example, in other embodiments other peripheral devices such as optical-disk media, audio adapters, or chip programming devices, such as PAL or EPROM programming devices are used in addition to or in place of the hardware already depicted.

Computer 110 can be implemented using any suitable computer such as a Macintosh or IBM-compatible personal computer available from a number of vendors. But, an embodiment of the present invention can apply to any hardware configuration that allows attachment of peripheral devices via a hub, regardless of whether the computer is a complicated, multi-user computer apparatus, a single-user workstation, a laptop or notebook computer, or a network appliance that does not have non-volatile storage of its own.

1. An apparatus, comprising:
a housing;
a power supply enclosed in the housing;
a bus hub enclosed in the housing, the power supply being coupled to the bus hub to supply power to the bus hub; and
a downstream receptacle in the housing connected to both the power supply and the bus hub, the downstream receptacle being coupled to a cable to couple power from the power supply and data signals from the bus hub to the cable and to receive power and data signals from the cable.

2. The apparatus of claim 1, wherein the bus hub further comprises an upstream port.

3. The apparatus of claim 1, wherein the bus hub comprises:
at least one downstream port to connect to at least one downstream device.

4. The apparatus of claim 1, wherein the bus hub is self powered.

5. The apparatus of claim 1, wherein the bus hub is bus powered.

6. The apparatus of claim 2, further comprising:
a hub repeater connected to the upstream port.

7. The apparatus of claim 1 wherein the power supply is coupled to receive alternating current (AC) power to convert the AC power into direct current (DC) power, the DC power being coupled to the downstream receptacle and to the bus hub.

8. The apparatus of claim 1 wherein the cable further comprises:
a device power wire to provide power to the bus hub;
a device ground wire;
a computer power wire to provide power from the power supply to a computer;
a computer ground wire; and
a plurality of signal wires to carry data signals between the computer and the bus hub.

9. The apparatus of claim 8, wherein the plurality of signal wires further comprises a signal twisted pair.

10. The apparatus of claim 8, wherein the plurality of signal wires further comprises a fiber optic channel.

11. The apparatus of claim 1, wherein the power supply is coupled to a wire to receive alternating current (AC) power, the power supply to convert the AC power into direct current (DC) power.

12. A computing unit, comprising:
a computer comprising:
an upstream receptacle to deliver data signals to the computer; and
a power receptacle to deliver electrical power to the computer; and
a power hub coupled to the upstream receptacle and the power receptacle via a cable, wherein
the power hub comprises:
a housing;
a power supply enclosed in the housing, the power supply being coupled to the cable to provide power to the computer; and
a bus hub enclosed in the housing, the bus hub being coupled to the cable to receive power and data signals from the computer and the power supply being coupled to the bus hub to supply power to the bus hub.

13. The computing unit of claim 12, wherein the cable further comprises:
a device power wire to provide power from the computer to the power hub;
a device ground wire;
a computer power wire to provide power from the power supply to the computer;
a computer ground wire; and
a plurality of signal wires to carry data signals between the computer and the power hub.

14. The computing unit of claim 13, wherein the plurality of signal wires comprises a twisted pair.

15. The computing unit of claim 13, wherein the plurality of signal wires comprises a fiber optic channel.

16. The computing unit of claim 12, wherein the bus hub further comprises an upstream port.

17. The computing unit of claim 12, wherein the bus hub further comprises:
at least one downstream port to connect to at least one downstream device.

18. The computing unit of claim 16, wherein the bus hub further comprises:
a hub repeater connected to the upstream port.

19. The computing unit of claim 12, wherein the bus hub is self powered.

20. The computing unit of claim 12, wherein the bus hub is bus powered.

21. A cable comprising:
a device power wire to provide power from a computer to a power hub;
a device ground wire;
a computer power wire to provide power from the power hub to the computer;
a computer ground wire; and
a plurality of signal wires to carry data signals between the computer and the power hub.

22. The cable of claim 21, wherein the cable further comprises:
an upstream plug to connect to both an upstream bus receptacle and a power receptacle, wherein the power receptacle draws electric power from the computer power wire.

23. The cable of claim 21, further comprising:
a downstream plug to electrically connect to both a downstream bus receptacle and a power receptacle, wherein the power receptacle is to supply electric power to the computer power wire, and wherein the downstream bus receptacle is connected to the device power wire, the device ground wire, and the plurality of signal wires.

24.-25. (Canceled)

26. The cable of claim 21 wherein the plurality of signal wires comprises a twisted pair.

27. The cable of claim 21 wherein the plurality of signal wires comprises a fiber optic channel.

28. The computing unit of claim 12 wherein the power supply is coupled to receive alternating current (AC) power to convert the AC power into direct current (DC) power, the DC power being coupled to the cable and to the bus hub.

29. An apparatus comprising:
a housing;
a power supply enclosed in the housing, the power supply being coupled to receive alternating current (AC) power to convert the AC power into direct current (DC) power;
a bus hub enclosed in the housing, the bus hub being coupled to the power supply to receive DC power from the power supply; and
a downstream receptacle in the housing connected to both the power supply and the bus hub, the downstream receptacle being coupled to a cable to couple DC power from the power supply and data signals from the bus hub to the cable and to receive DC power and data signals from the cable.

30. The apparatus of claim 29 wherein the bus hub further comprises a root port.

31. The apparatus of claim 29 wherein the bus hub further comprises a downstream port to be coupled to a downstream device.

32. The apparatus of claim 29 wherein the bus hub is self powered.

33. The apparatus of claim 29 wherein the bus hub is bus powered.

34. The apparatus of claim 29, further comprising a hub repeater coupled between a root port and a plurality of downstream ports in the bus hub to manage connections to and through the bus hub, each downstream port to be coupled to a downstream device.

35. The apparatus of claim 34 wherein the downstream devices comprise one or more of a mouse, a speaker, a telephone, a keyboard, a joystick, a camera, a modem, a scanner, and a printer.

36. The apparatus of claim 34, further comprising a hub controller coupled to the hub repeater in the bus hub to route signals between the root port and the downstream ports and to perform error detection and recovery.

37. The apparatus of claim 36 wherein the hub controller and the hub repeater comprise memory stored instructions executable by a processor or logic gates or a programmable logic device.

38. The apparatus of claim 29 wherein the cable further comprises:
a device power wire to provide DC power to the bus hub;
a device ground wire;
a computer power wire to provide DC power from the power supply to a computer;
a computer ground wire; and
a plurality of signal wires to carry data signals between the computer and the bus hub.

39. A computing unit, comprising:
a computer comprising:
an upstream receptacle to deliver data signals to the computer; and
a power receptacle to deliver electrical power to the computer; and
a power hub coupled to the upstream receptacle and the power receptacle of the computer via a
cable, wherein the power hub comprises:
a housing;
a power supply enclosed in the housing, the power supply being coupled to receive alternating current (AC) power to convert the AC power into direct current (DC) power, the power supply being coupled to the cable to provide DC power to the computer; and
a bus hub enclosed in the housing, the bus hub being coupled to the power supply to receive DC power from the power supply and to the cable to receive power and data signals from the computer.

40. The computing unit of claim 39, wherein the cable further comprises:
a device power wire to provide DC power from the computer to the power hub;
a device ground wire;
a computer power wire to provide DC power from the power supply to the computer;
a computer ground wire; and
a plurality of signal wires to carry data signals between the computer and the power hub.

41. The computing unit of claim 39 wherein the bus hub further comprises a root port.

42. The computing unit of claim 39 wherein the bus hub further comprises a downstream port to be coupled to a downstream device.

43. The computing unit of claim 39 wherein the bus hub is self powered.

44. The computing unit of claim 39 wherein the bus hub is bus powered.

45. The computing unit of claim 39, further comprising a hub repeater coupled between a root port and a plurality of downstream ports in the bus hub to manage connections to and through the bus hub, each downstream port to be coupled to a downstream device.

46. The computing unit of claim 45 wherein the downstream devices comprise one or more of a mouse, a speaker, a telephone, a keyboard, a joystick, a camera, a modem, a scanner, and a printer.

47. The computing unit of claim 45, further comprising a hub controller coupled to the hub repeater in the bus hub to route signals between the root port and the downstream ports and to perform error detection and recovery.

48. The computing unit of claim 47 wherein the hub controller and the hub repeater comprise memory stored instructions executable by a processor or logic gates or a programmable logic device.
